(19) United States
(12) Patent Application Publication
(10) Pub. No.: US 2026/0349464 A1
(43) Pub. Date: Nov. 5, 2026

(54) USING MULTICYCLE PROPERTIES TO REDUCE PERFORMANCE OVERHEAD OF CLOCK CONTROL AND TRIGGER OPERATIONS IN EMULATION OR PROTOTYPING

(71) Applicant: Synopsys, Inc., Mountain View, CA (US)

(72) Inventors: Alexander Rabinovitch, Shrewsbury, MA (US); Baijayanta Ray, Bangalore (IN)

(73) Assignee: Synopsys, Inc., Mountain View, CA (US)

(21) Appl. No.: 18/156,566

(22) Filed: Jan. 19, 2023

(51) Int. Cl. G06F 1/04; G06F 30/34; G06F 119/12; H03K 5/01

(52) U.S. Cl. CPC G06F 1/04; G06F 30/34; H03K 5/01; G06F 2119/12

(57) ABSTRACT

A first circuit may be received which generates a ready signal, where the ready signal is used to stop and resume a set of clock signals in an emulation system, where the set of clock signals is derived from a first clock signal in the emulation system, where the first circuit includes at least one circuit element which is clocked by a second clock signal in the set of clock signals, and where the second clock signal is slower than the first clock signal. The first circuit may be replaced by a second circuit which is clocked by the first clock signal, and where the second circuit predicts a value of the ready signal at a future clock edge of the second clock signal.

### TECHNICAL FIELD

The present disclosure generally relates to circuit emulation and prototyping. More specifically, the present disclosure relates to using multicycle properties to reduce performance overhead of clock control and trigger operations in emulation or prototyping.

### BACKGROUND

Emulation and prototyping may refer to replicating the behavior of an integrated circuit (IC) design using an emulation system. The emulation system may be created based on hardware description language code which describes the functionality of the IC design. The emulation system may be used to verify the IC design.

### SUMMARY

A first circuit may be received which generates a ready signal, where the ready signal is used to stop and resume a set of clock signals in an emulation system, where the set of clock signals is derived from a first clock signal in the emulation system, where the first circuit includes at least one circuit element which is clocked by a second clock signal in the set of clock signals, and where the second clock signal is slower than the first clock signal. The first circuit may be replaced by a second circuit which is clocked by the first clock signal, and where the second circuit predicts a value of the ready signal at a future clock edge of the second clock signal.

In some embodiments described herein, the second clock signal may be generated by aligning each clock edge of a third clock signal to a corresponding positive clock edge of the first clock signal. In some embodiments described herein, the corresponding positive clock edge of the first clock signal may be a positive clock edge of the first clock signal which is nearest to, and which occurs before the clock edge of the third clock signal. In some embodiments described herein, the corresponding positive clock edge of the first clock signal may be a positive clock edge of the first clock signal which is nearest to, and which occurs after the clock edge of the third clock signal.

In some embodiments described herein, a first clock frequency of the first clock signal may be greater than or equal to two times a second clock frequency of the second clock signal.

In some embodiments described herein, each clock signal in the set of clock signals may be generated by a respective clock generator circuit in a set of clock generator circuits. Specifically, the ready signal may be provided to enable pins of the set of clock generator circuits.

### BRIEF DESCRIPTION OF THE FIGURES

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates stopping and resuming clocks in an emulation system in accordance with some embodiments described herein.

FIGS. 2A-2B illustrates signal prediction in accordance with some embodiments described herein.

FIGS. 3A-3B illustrate using prediction to reduce the timing criticality of a circuit path which evaluates a ready signal in accordance with some embodiments described herein.

FIG. 4 illustrates mapping edges of a slower clock to edges of a faster clock in accordance with some embodiments described herein.

FIG. 5 illustrates a process for using multicycle properties to reduce performance overhead of clock control and trigger operations in emulation and prototyping in accordance with some embodiments described herein.

FIG. 6 illustrates an example set of processes used during the design, verification, and fabrication of an article of manufacture such as an integrated circuit to transform and verify design data and instructions that represent the integrated circuit.

FIG. 7 depicts a diagram of an example emulation system in accordance with some embodiments of the present disclosure.

FIG. 8 illustrates an example machine of a computer system within which a set of instructions, for causing the machine to perform any one or more of the methodologies discussed herein, may be executed.

### DETAILED DESCRIPTION

Aspects of the present disclosure relate to using multicycle properties to reduce performance overhead of clock control and trigger operations in emulation or prototyping. Emulation and/or prototyping systems may imitate the functionality of a design under test (DUT). A set of local clock signals that represent primary clocks of the DUT may be maintained independently (and in unison) in multiple physical locations across the emulation system. Local clock signals in different portions of the emulation system (e.g., different field programmable gate arrays (FPGAs)) may be maintained independently because creating a clock signal in a single location in the emulation system and distributing the clock signal to every clock sink in the emulation system may incur an unreasonably large propagation delay and/or use dedicated hardware resources which may be costly. Although some descriptions herein are in the context of emulation systems, these descriptions also apply to prototyping systems. Thus, in this disclosure, the term “emulation system” refers to both emulation systems and prototyping systems.

When an IC chip is fabricated based on the DUT, the IC chip may be able to perform a specific operation within a clock cycle, but the emulation system may not be able to perform the operation within a single clock cycle. In such cases, the emulation system may need to stop and resume clocks. For example, consider the following use of a direct programming interface (DPI) call in System Verilog:
always @(posedge ck)
a<=dpi_func(b);
   In the above example, the emulation clock “ck” may need to be stopped upon positive edge (posedge) of the emulation clock “ck” because the current emulation clock cycle is not over until the function “dpi_func” (which may be defined in a high level programming language such as C++) completes execution by a processing device and the return value is communicated to the emulator and assigned to the variable “a”. In other words, the emulation clock may need to be stopped and resumed to ensure that the emulation system accurately imitates the behavior of the IC chip in each clock cycle (i.e., to ensure that the emulation system is “cycle-accurate”).

If the emulation system (also referred to herein as an emulator) guarantees that the command to start clocks reaches all FPGAs simultaneously, the clock signals generated independently in multiple physical locations across the emulation system are also guaranteed to start in unison.

The request to stop the clocks can occur at any time in any field programmable gate array (FPGA). The request to stop the clocks must be communicated to every FPGA before the next clock edge so that the clocks in the emulation system can be stopped in unison before the emulation system advances to the next clock edge. The process of communicating the request to stop the clocks can be time critical, i.e., this process may limit the maximum speed of the emulation system.

Embodiments described herein may not pause clock domains which are clocked using slower clocks until the next positive clock edge of the fastest clock signal arrives, which may substantially increase the amount of time needed to determine whether to pause the emulation clock. Thus, embodiments described herein may reduce the time criticality of stopping and resuming clocks in the emulation system. Specifically, some embodiments described herein may predict signal values in the circuitry which stops and resumes clocks, where predicting signal values may reduce the time criticality of stopping and resuming clocks in the emulation system.

Technical advantages of embodiments described herein include, but are not limited to, improving the performance of emulation systems (e.g., by increasing the maximum clock speed at which the emulation system can operate). Specifically, embodiments described herein may reduce the amount of time used by an emulation system to perform an emulation run, i.e., if the emulation run uses 10 minutes to complete, then embodiments described herein may reduce the amount of time to 5 minutes or less.

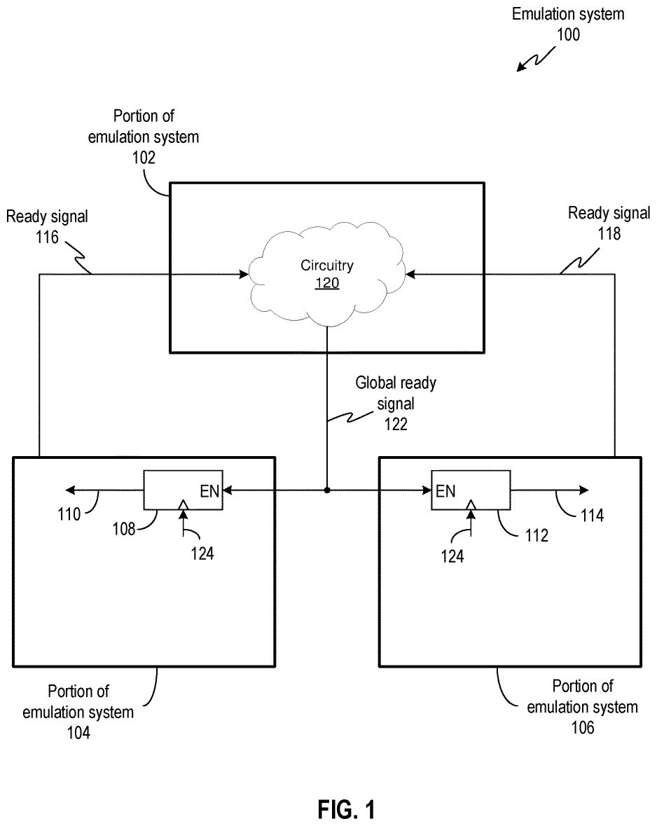

FIG. 1 illustrates stopping and resuming clocks in an emulation system in accordance with some embodiments described herein.

Emulation system 100 (or emulation environment 700) may include portions of emulation system 102, 104, and 106. Each portion of emulation system may include one or more FPGAs, specialized Application Specific Integrated Circuits (ASICs) for emulation or prototyping, processors, memories, and/or input/output devices, which may be located on one or more boards.

Each portion of the emulation system may generate a local clock signal using a clock generator circuit. For example, portion of emulation system 104 may include clock generator circuit 108 which generates local clock signal 110, and portion of emulation system 106 may include clock generator circuit 112 which generates local clock signal 114. Local clock signals 110 and 114 may be used to clock circuitry (e.g., registers) in portions of emulations systems 104 and 106, respectively.

A clock generator may generate the clock signal based on a master clock signal that it receives as input. For example, clock generator circuit 108 may generate clock signal 110 based on master clock signal 124, and clock generator circuit 112 may generate clock signal 114 based on master clock signal 124. The master clock signal may be the fastest clock signal in the emulation system and may be distributed to the clock generator circuits in the different portions of the emulation system.

A clock generator circuit may include an enable pin which may be used to stop and resume the local clock signal. For example, clock generator circuits 108 and 112 may each include an enable pin (shown in FIG. 1 as “EN”) which may be used to stop and resume local clock signals 110 and 114, respectively. For example, when an enable pin of a clock generator circuit is deasserted (e.g., a logic “0” signal is provided to the enable pin), the local clock signal may be stopped, and when the enable pin of the clock generator circuit is asserted (e.g., a logic “1” signal is provided to the enable pin), the local clock may be resumed.

Each portion of the emulation system may generate a ready signal that indicates that the circuitry in the portion of the emulation system has completed the operations that were desired to be completed before the next clock edge and is now ready to advance to the next clock edge. For example, ready signals 116 and 118 may be generated by portions of emulation system 104 and 106, respectively. Circuity 120 in portion of emulation system 102 may use ready signals 116 and 118 to determine whether emulation system 100 can advance to the next clock edge. Specifically, circuitry 120 may generate global ready signal 122 which may be provided to the enable pins of the clock generators in the emulation system, e.g., enable pins of clock generator circuits 108 and 112.

Circuity 120 may stop and resume clocks in unison in the emulation system 100 by using global ready signal 122. For example, if either ready signal 116 indicates that the portion of the emulation system 104 is not ready to advance to the next clock edge or ready signal 118 indicates that the portion of the emulation system 106 is not ready to advance to the next clock edge, then circuity 120 may deassert global ready signal 122 which may cause clock generator circuits 108 and 112 to stop clocks 110 and 114, respectively. Subsequently, when both ready signal 116 and ready signal 118 indicate that the corresponding portions of the emulation system are ready to advance to the next clock edge, circuity 120 may assert global ready signal 122 which may cause clock generator circuits 108 and 112 to resume clocks 110 and 114, respectively.

The circuit path which generates and routes the ready signals (e.g., ready signals 116 and 118) from each portion of the emulation system to a central location (e.g., circuitry 120), evaluates a global ready signal (e.g., global ready signal 122) based on the ready signals, and distributes the global ready signal to each portion of the emulation system (e.g., providing global ready signal 122 to the enable pins of clock generator circuits 108 and 112) can have a large delay and may become a performance bottleneck for an emulation system. In other words, the fastest clock speed at which an emulation system may be operated may depend on the delay of the above-described circuit path.

Embodiments described herein may not pause clock domains which are clocked using slower clocks until the next positive clock edge of the fastest clock signal arrives, which may substantially increase the amount of time needed to determine whether to pause the emulation clock.

Embodiments described herein are presented in the context of using prediction to reduce the time criticality of the circuit path for generating the global ready signal. However, techniques described herein may generally be applied to any arbitrary trigger condition, which may include, but are not limited to, start capturing waveform and start a memory update. A trigger condition may generally refer to any combinational logic which is used to determine whether a clock can be advanced to the next clock edge.

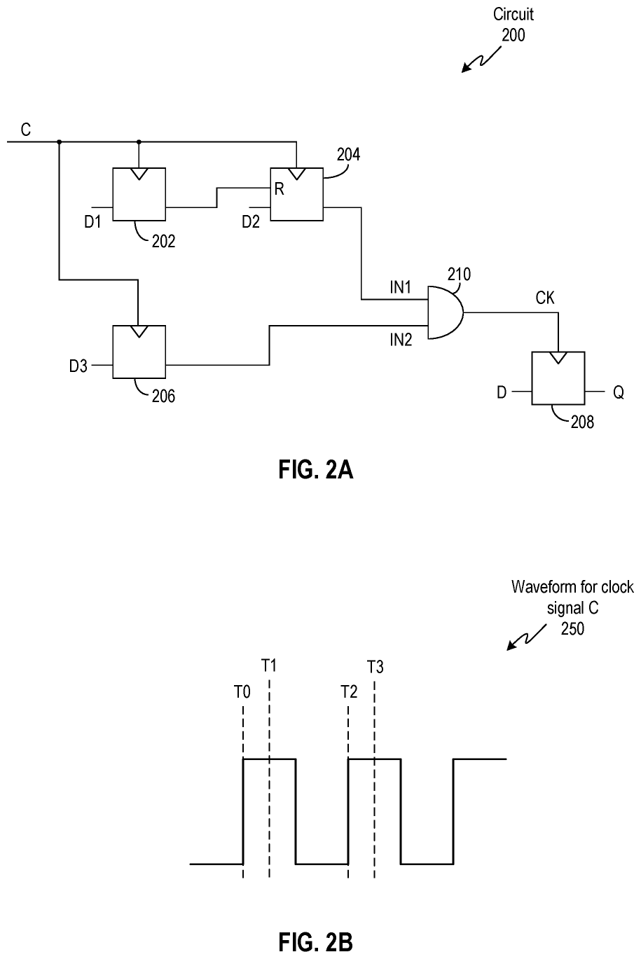

FIGS. 2A-2B illustrates signal prediction in accordance with some embodiments described herein.

Circuit 200 in FIG. 2A includes registers 202, 204, 206, and 208, and AND gate 210. The output of register 202 is provided to the reset input R of register 204. Data input signals D1, D2, D3, and D correspond to registers 202, 204, 206, and 208. Signal Q is the output of register 208. Clock signal C clocks registers 202, 204, and 206. Input signals IN1 and IN2 correspond to the inputs of AND gate 210. Clock signal CK is generated as shown by circuit 200, and clock signal CK clocks register 208. The operation of the circuit 200 may be specified using the following code:
Line 1.1: CK=IN1 & IN2;
Line 1.2: always @(posedge C or posedge R) begin
Line 1.3: if (R) IN1<=0;
Line 1.4: else IN1<=D2;
Line 1.5: end
Line 1.6: always @(posedge C) begin
Line 1.7: IN2<=D3;
Line 1.8: R<=D1;
Line 1.9: end
Line 1.10: always @(posedge CK) Q<=D;

FIG. 2B illustrates waveform 250 for clock signal “C.” A positive clock edge occurs at time instances T0 and T2. Suppose the values of D1, D2, and D3 are stable and are known at time instance T1. Thus, at the positive clock edge that occurs at time instance T2, the code in lines 1.2 to 1.9 is executed, and the resulting value of CK (as per line 1.1) may be evaluated. Suppose the value of CK changes from a logical 0 to a logical 1, and this positive edge in the clock signal CK will cause the value of Q to be equal to D (as shown in line 1.10). For example, the next value of Q will be stable at time instance T3.

The next value of Q (i.e., the value at time instance T3) may be predicted as follows. The next value of each signal may be referred to by adding the suffix “_next” to the signal. Thus, CK_next refers to the next (or predicted) value of CK, IN1_next refers to the next (or predicted) value of signal IN1, and so forth. Using this notation, the following code illustrates how the predicted value of clock CK and register output Q may be determined.
Line 2.1: CK next=IN1_next & IN2_next;
Line 2.2: IN2_nex=D3;
Line 2.3: IN1_next =R_next? 0: D2;
Line 2.4: R next=D1;
Line 2.5: Q_next=(CK_next & ~CK)? D:Q;
Line 2.6: always @(posedge C) if (CK_next & ~CK) Q<=Q_next;
Line 2.7: always @(posedge C) CK<=CK_next;

The next values (i.e., predicted values) of signals (i.e., signals CK_next, IN_next, IN2_next, R_next, and Q_next) corresponds to the value of the signals at time instance T3, i.e., after positive clock edge T2. Specifically, the value of CK_next may be evaluated using the stable and known values of D1, D2, and D3 at time T1 using the combinational logic described in lines 2.1-2.4. The condition “(CK_next & ~CK)” in line 2.5 is true when clock “CK” has a positive clock edge. Thus, the combinational logic shown in line 2.5 specifies that the future value of signal “Q” (i.e., Q_next) will either be equal to Q if clock CK does not have a positive clock edge, or D if clock CK has a positive clock edge. In other words, the combinational logic shown in lines 2.1 through 2.5 may be used to predict the next values of CK and Q, and these values may then be assigned based on clock C as shown in lines 2.6 and 2.7. It will be noted that lines 2.1 through 2.7 are functionally equivalent to lines 1.1 through 1.10. The code in lines 1.1 through 1.10 evaluates the next value of Q and CK at time T3. On the other hand, the code in lines 2.1 through 2.7 can evaluate the next value of Q and CK significantly earlier, e.g., soon after time T1. In other words, the code shown in lines 2.1 through 2.7 may be used to predict future values of Q and CK.

The prediction technique described above may be applied recursively. For example, the register 208 in circuit 200 is clocked by clock signal CK, i.e., line 1.10 in the code. After transforming the circuit, all circuit elements were clocked by clock signal C, i.e., compare line 2.6 with line 1.10 in the code. If clock signal C is derived from a master clock signal, then the prediction technique may be used to recursively so that all circuit elements are clocked by the master clock signal instead of clock signal C.

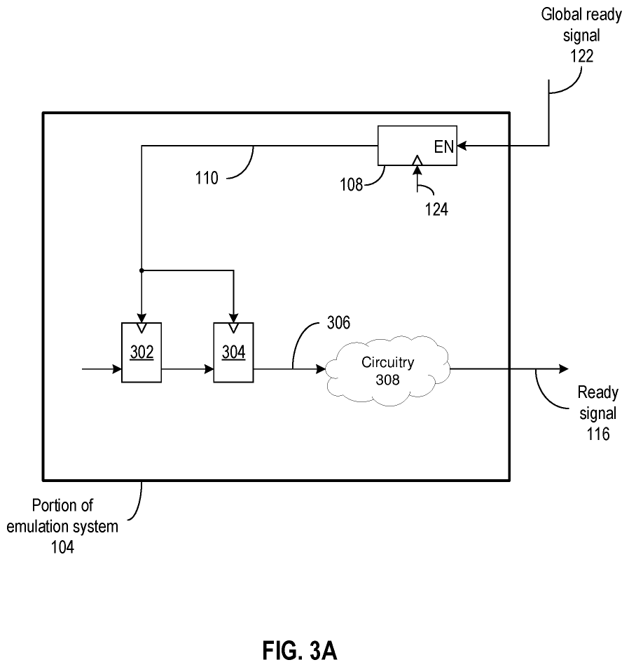

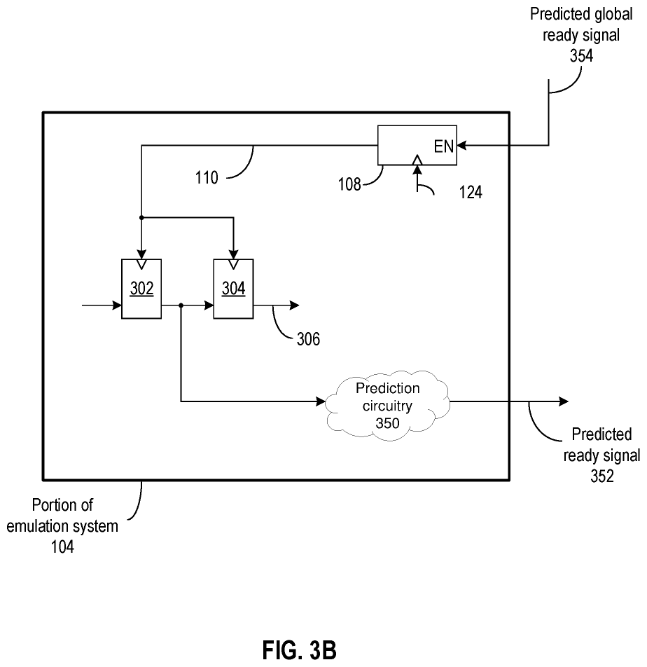

FIGS. 3A-3B illustrate using prediction to reduce the timing criticality of a circuit path which evaluates a ready signal in accordance with some embodiments described herein.

Portion of emulation system 104 may include clock generator circuit 108 which generates local clock signal 110. The enable pin of clock generator circuit 108 may receive global ready signal 122, which may be used to stop and resume local clock signal 110.

In portion of emulation system 104, clock signal 306 may be generated based on local clock signal 110, where the frequency of clock signal 306 is less than or equal to half of the clock frequency of local clock signal 110. For example, signal 306 may be generated using a pair of registers 302 and 304. Ready signal 116 may be generated by circuitry 308 which may be clocked based on clock signal 306.

In FIG. 3A, ready signal 116 may become stable after a positive edge PE1 of clock signal 306 is processed by circuitry 308. Ready signal 116 may then be routed to a central location, and global ready signal 122 may be evaluated based on the ready signals received from different portions of the emulation system. This circuit path may have a large delay and may become a performance bottleneck for an emulation system.

Embodiments described herein may use signal prediction to evaluate the ready signal 116 significantly before positive edge PE1 of clock signal 306 is received, which may significantly reduce the delay of the circuit path and, which in turn, may alleviate the performance bottleneck.

Specifically, as shown in FIG. 3B, predicted ready signal 352 may be generated by prediction circuitry 350 which uses the output of register 302 for generating predicted ready signal 350 and is clocked using local clock signal 110. Clock signal 306 may continue to be used to clock other circuitry in portion of emulation system 104.

For example, clock signal 110 may correspond to clock signal C in lines 1.2, and clock signal 306 may correspond to clock signal CK in line 1.7. After transformation, prediction circuitry 350 may correspond to lines 2.1 through 2.7. It is noted that circuit elements in lines 2.1 through 2.7 are clocked by clock signal C (i.e., clock signal 110) and not clock signal CK (i.e., clock signal 306). It is also noted that prediction circuitry 350 may use the value of clock signal 306 but is not clocked by clock signal 306. For example, line 2.6 uses the value of clock signal CK in the condition “(CK_next & ~CK)” but is clocked by the positive edge of clock signal C.

The predicted ready signal 352 may then be used to generate a predicted global ready signal 354. Predicted global ready signal 354 may then be used to stop clocks in the emulation system. The logic for using the predicted global ready signal 354 to stop clocks (and keep them stopped) in the emulation system may be represented using the following code:
Line 3.1: always @(posedge pclk) begin
Line 3.2: if (~((trigger_next & pos_C)|stopped) )
Line 3.3: C<=~C;
Line 3.4: end;
Line 3.5: always @(posedge pclk)
Line 3.6: if(trigger_next & pos_C) stopped<=1;

In the above code, clock signal pclk is the master clock signal (e.g., master clock signal 124) and the signal trigger_next is the negation (or inverse) of the predicted global ready signal 354. The signal pos_C is a logic “1” when the positive edge of the clock signal pclk (e.g., master clock signal 124) coincides with the positive edge (or rising edge) of clock signal C (e.g., clock signal 110). Because signal pos_C may be short lived (e.g., this signal may not be a logic “1” in the next cycle of clock signal pclk), an auxiliary register “stopped” in the above code is used to keep the clocks stopped. Lines 3.5 and 3.6 store a logic “1” value in register “stopped” when trigger_next is a logic “1” and pos_C is a logic “1”. Lines 3.1-3.4 will not advance the clock signal C if the “stopped” register has a logic “1” value or the expression “trigger_next & pos_C” evaluates to a logic “1” value. Register “stopped” may be cleared (which causes the value stored in register “stopped” to be equal to a logic “0”) when the clocks are restarted. The signal pos_C may be generated based on the value of the conditional in the if statement in Line 3.2 and the value of C. In general, suppose clock signal C is advanced at the positive edge of clock signal pclk when condition “cond” evaluates to a logic “1”, i.e., always @(posedge pclk) if (cond) C<=~C. In this example, pos_C is equal to “1” when “cond” evaluates to a logic “1” and C is equal to a logic “0”, i.e., pos_C=(cond & ~C).

In some embodiments described herein, all local clocks in the emulation system may be derived from a common fastest clock in the emulation system. In these embodiments, the prediction technique may be applied recursively so that the circuitry that generates the global ready signal 122 may be clocked by the common fastest clock in the emulation system.

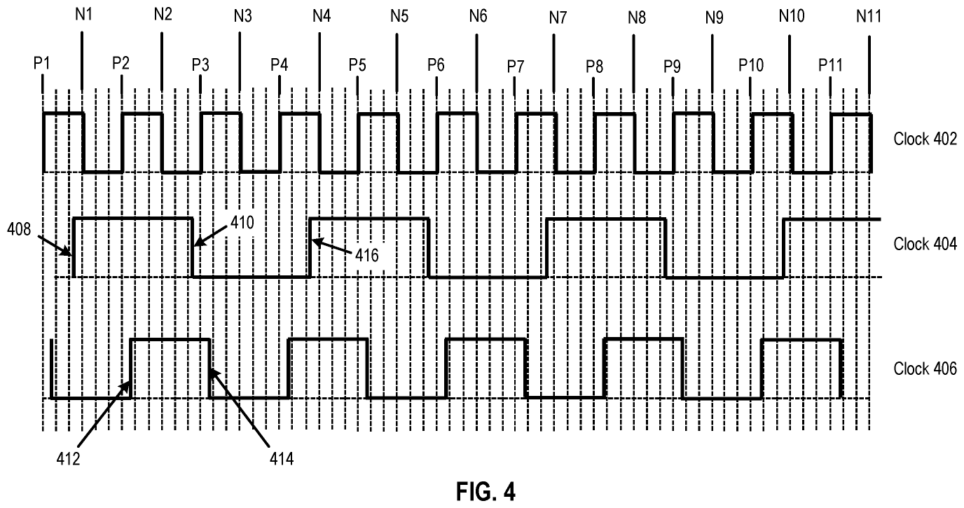

FIG. 4 illustrates mapping edges of a slower clock to edges of a faster clock in accordance with some embodiments described herein.

Embodiments described herein may also be used when the slower local clocks are not aligned (i.e., the clocks are skewed or out of phase) with the fastest clock in the emulation system. Specifically, each clock edge (positive and negative) of the slower clock may be mapped to a corresponding positive clock edge of the fastest clock in the emulation system. The resulting slower clock may not have a 50% duty cycle but will have the same clock frequency as before.

For example, clocks 402, 404, and 406 may be used in an emulation system. Clock 402 may be the fastest clock in the emulation system. The positive edges of clock 402 are labeled as P1-P11 and the negative clock edges of clock 402 are labeled as N1-N11. Clock 404 may operate at a speed which is three times slower than clock 402, and clock 406 may operate at a speed which is two times slower than clock 402. As shown in FIG. 4, clocks 404 and 406 may have a phase shift with respect to clock 402.

Each edge of clock 404 may be mapped or aligned with a corresponding positive edge of clock 402. For example, in one embodiment, each edge of clock 404 may be mapped or aligned with the most recent positive edge of clock 402, i.e., positive edge 408 of clock 404 may be mapped to positive edge P1 of clock 402, negative edge 410 of clock 404 may be mapped to positive edge P2 of clock 402, and positive edge 416 of clock 404 may be mapped to positive edge P4 of clock 402. Likewise, each edge of clock 406 may be mapped to the most recent positive edge of clock 402, i.e., positive edge 412 of clock 406 may be mapped to positive edge P2 of clock 402 and negative edge 414 of clock 406 may be mapped to positive edge P3 of clock 406. In other embodiments, each edge of clock 404 may be mapped or aligned with the nearest subsequent positive edge of clock 402, i.e., positive edge 408 of clock 404 may be mapped to positive edge P2 of clock 402, and so forth. If a second clock signal (e.g., clock 404 or 406) operates at a speed which is two times slower (or even slower than two times slower) than a first clock signal (e.g., clock 402), then a positive (or rising) edge of the first clock signal exists between any two consecutive edges of the second clock signal. For example, positive clock edge P2 of clock 402 exists between positive clock edge 408 and negative clock edge 410 of clock 404. Likewise, positive clock edge P3 exists between positive clock edge 412 and negative clock edge 414 of clock 406.

Once the edges of clocks 404 and 406 have been mapped to the fastest clock, embodiments described herein may be used to create prediction circuitry that is clocked using the fastest clock. Thus, embodiments described herein may be used when the slower clocks in the emulation system are not phase aligned with the fastest clock.

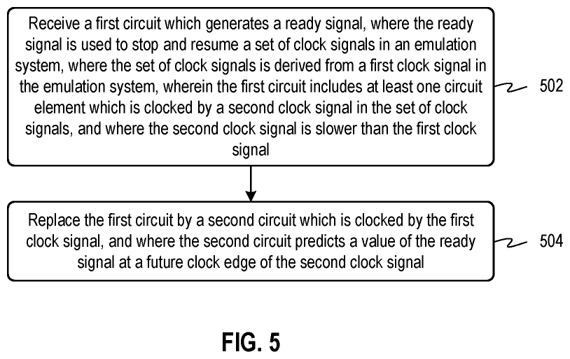

FIG. 5 illustrates a process for using multicycle properties to reduce performance overhead of clock control and trigger operations in emulation and prototyping in accordance with some embodiments described herein.

A first circuit may be received which generates a ready signal, where the ready signal is used to stop and resume a set of clock signals in an emulation system, where the set of clock signals is derived from a first clock signal in the emulation system, wherein the first circuit includes at least one circuit element which is clocked by a second clock signal in the set of clock signals, and where the second clock signal is slower than the first clock signal (at 502). For example, the first circuit may include circuity 308 in FIG. 3A. Circuitry 308 may include at least one circuit element which is clocked by clock signal 306 (i.e., the second clock signal) which is slower than the master clock signal 124 (i.e., the first clock signal).

The first circuit may be replaced by a second circuit which is clocked by the first clock signal, and where the second circuit predicts a value of the ready signal at a future clock edge of the second clock signal (at 504). For example, circuitry 308 may be replaced with prediction circuitry 350 in FIG. 3B which is clocked by master clock signal 124.

In some embodiments described herein, the second clock signal may be generated by aligning each clock edge of a third clock signal to a corresponding positive clock edge of the first clock signal. For example, clock 402 may be the first clock signal, clock 404 in FIG. 4 may be the third clock signal, and the edges of clock 404 (i.e., the third clock signal) may be aligned to corresponding positive edges of clock 402 (i.e., the first clock signal).

In some embodiments, the corresponding positive clock edge of the first clock signal may be a positive clock edge of the first clock signal which is nearest to, and which occurs before the clock edge of the third clock signal. In some embodiments, the corresponding positive clock edge of the first clock signal may be a positive clock edge of the first clock signal which is nearest to, and which occurs after the clock edge of the third clock signal.

In some embodiments described herein, first clock frequency of the first clock signal (e.g., clock 402 in FIG. 4) may be greater than or equal to two times a second clock frequency of the second clock signal (e.g., clock 404 after edge alignment).

In some embodiments described herein, each clock signal in the set of clock signals may be generated by a respective clock generator circuit in a set of clock generator circuits. For example, clock signals 110 and 114 are generated by clock generator circuits 108 and 112. In some embodiments described herein, the ready signal (e.g., global ready signal 122) may be provided to enable pins of the set of clock generator circuits (e.g., circuit generator circuits 108 and 112).

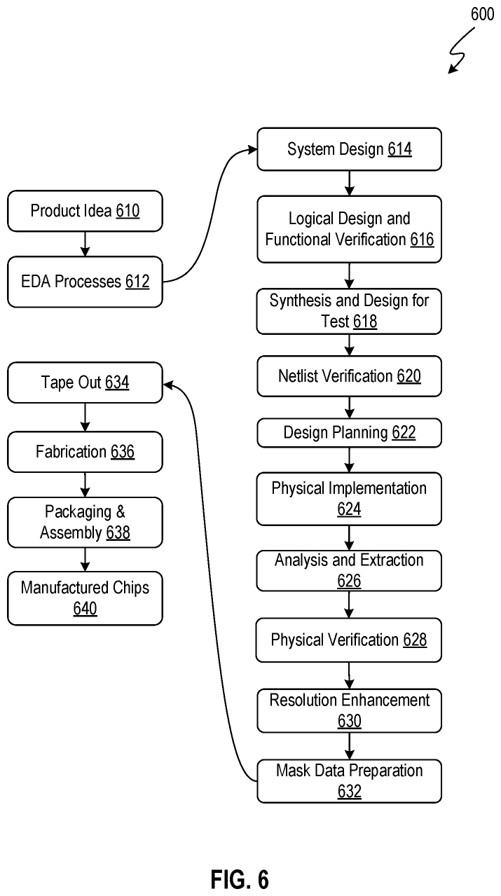

FIG. 6 illustrates an example set of processes 600 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 610 with information supplied by a designer, information which is transformed to create an article of manufacture that uses a set of EDA processes 612. When the design is finalized, the design is taped-out 634, which is when artwork (e.g., geometric patterns) for the integrated circuit is sent to a fabrication facility to manufacture the mask set, which is then used to manufacture the integrated circuit. After tape-out, a semiconductor die is fabricated 636 and packaging and assembly processes 638 are performed to produce the finished integrated circuit 640.

Specifications for a circuit or electronic structure may range from low-level transistor material layouts to high-level description languages. A high-level of representation may be used to design circuits and systems, using a hardware description language (‘HDL’) such as VHDL, Verilog, System Verilog, SystemC, MyHDL or Open Vera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 6. The processes described by be enabled by EDA products (or EDA systems).

During system design 614, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 616, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 618, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 620, the netlist is checked for compliance with timing constraints and for correspondence with the HDL code. During design planning 622, an overall floor plan for the integrated circuit is constructed and analyzed for timing and top-level routing.

During layout or physical implementation 624, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 626, the circuit function is verified at the layout level, which permits refinement of the layout design. During physical verification 628, the layout design is checked to ensure that manufacturing constraints are correct, such as DRC constraints, electrical constraints, lithographic constraints, and that circuitry function matches the HDL design specification. During resolution enhancement 630, the geometry of the layout is transformed to improve how the circuit design is manufactured.

During tape-out, data is created to be used (after lithographic enhancements are applied if appropriate) for production of lithography masks. During mask data preparation 632, the ‘tape-out’ data is used to produce lithography masks that are used to produce finished integrated circuits.

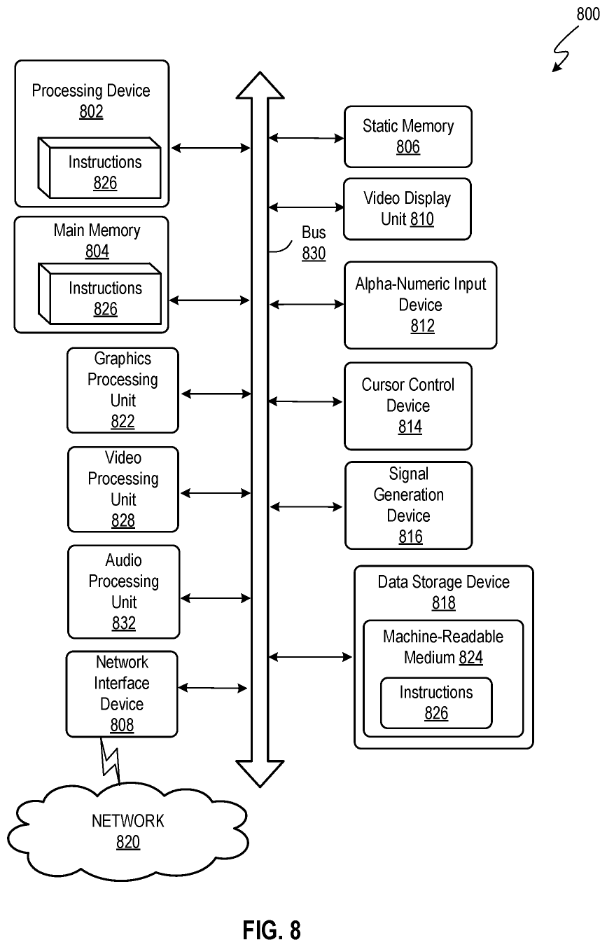

A storage subsystem of a computer system (such as computer system 800 of FIG. 8) may be used to store the programs and data structures that are used by some or all of the EDA products described herein, and products used for development of cells for the library and for physical and logical design that use the library.

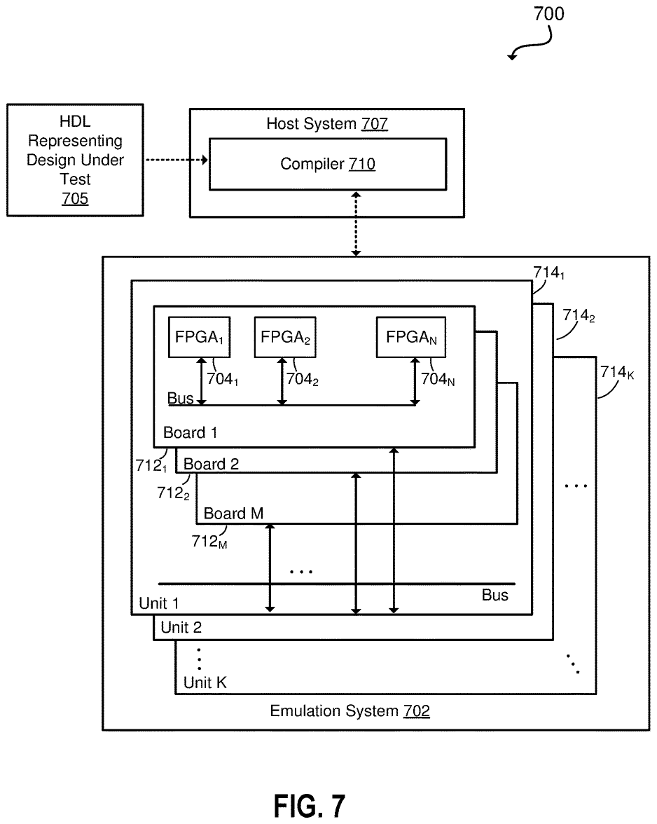

FIG. 7 depicts a diagram of an example emulation environment 700. An emulation environment 700 may be configured to verify the functionality of the circuit design. The emulation environment 700 may include a host system 707 (e.g., a computer that is part of an EDA system) and an emulation system 702 (e.g., a set of programmable devices such as Field Programmable Gate Arrays (FPGAs) or processors). The host system generates data and information by using a compiler 710 to structure the emulation system to emulate a circuit design. A circuit design to be emulated is also referred to as a Design Under Test (‘DUT’) where data and information from the emulation are used to verify the functionality of the DUT.

The host system 707 may include one or more processors. In the embodiment where the host system includes multiple processors, the functions described herein as being performed by the host system can be distributed among the multiple processors. The host system 707 may include a compiler 710 to transform specifications written in a description language that represents a DUT and to produce data (e.g., binary data) and information that is used to structure the emulation system 702 to emulate the DUT. The compiler 710 can transform, change, restructure, add new functions to, and/or control the timing of the DUT.

The host system 707 and emulation system 702 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 802.11. The host system 707 and emulation system 702 can exchange data and information through a third device such as a network server.

The emulation system 702 includes multiple FPGAs (or other modules) such as FPGAs 7041 and 7042 as well as additional FPGAs to 704N. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAS, embodiments of emulators can include other types of logic blocks instead of, or along with, the FPGAs for emulating DUTs. For example, the emulation system 702 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 7041-704N may be placed onto one or more boards 7121 and 7122 as well as additional boards through 712M. Multiple boards can be placed into an emulation unit 7141. The boards within an emulation unit can be connected using the backplane of the emulation unit or any other types of connections. In addition, multiple emulation units (e.g., 7141 and 7142 through 714K) can be connected to each other by cables or any other means to form a multi-emulation unit system.

For a DUT that is to be emulated, the host system 707 transmits one or more bit files to the emulation system 702. The bit files may specify a description of the DUT and may further specify partitions of the DUT created by the host system 707 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 707 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 707 and/or the compiler 710 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 705 into gate level logic. For a DUT that is to be emulated, the design synthesizer sub-system receives a description of the DUT. If the description of the DUT is fully or partially in HDL (e.g., RTL or other level of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 8 illustrates an example machine of a computer system 800 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM), a static memory 806 (e.g., flash memory, static random access memory (SRAM), etc.), and a data storage device 818, which communicate with each other via a bus 830.

Processing device 802 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 may be configured to execute instructions 826 for performing the operations and steps described herein.

The computer system 800 may further include a network interface device 808 to communicate over the network 820. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), a graphics processing unit 822, a signal generation device 816 (e.g., a speaker), graphics processing unit 822, video processing unit 828, and audio processing unit 832.

The data storage device 818 may include a machine-readable storage medium 824 (also known as a non-transitory computer-readable medium) on which is stored one or more sets of instructions 826 or software embodying any one or more of the methodologies or functions described herein. The instructions 826 may also reside, completely or at least partially, within the main memory 804 and/or within the processing device 802 during execution thereof by the computer system 800, the main memory 804 and the processing device 802 also constituting machine-readable storage media.

In some implementations, the instructions 826 include instructions to implement functionality corresponding to the present disclosure. While the machine-readable storage medium 824 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 802 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

1. A method, comprising:
receiving a first circuit which generates a ready signal, wherein the first circuit provides the ready signal to a second circuit, wherein the ready signal is used to stop and resume a set of clock signals in an emulation system, wherein the set of clock signals is derived from a first clock signal in the emulation system, wherein the first circuit includes at least one circuit element which is clocked by a second clock signal in the set of clock signals, and wherein the second clock signal is slower than the first clock signal; and
replacing, by a processing device, the first circuit by a third circuit which is clocked by the first clock signal, and wherein the third circuit predicts a value of the ready signal at a future clock edge of the second clock signal.

2. The method of claim 1, further comprising generating the second clock signal by aligning each clock edge of a third clock signal to a corresponding positive clock edge of the first clock signal.

3. The method of claim 2, wherein the corresponding positive clock edge of the first clock signal is a positive clock edge of the first clock signal which is nearest to, and which occurs before the clock edge of the third clock signal.

4. The method of claim 2, wherein the corresponding positive clock edge of the first clock signal is a positive clock edge of the first clock signal which is nearest to, and which occurs after the clock edge of the third clock signal.

5. The method of claim 1, wherein a first clock frequency of the first clock signal is greater than or equal to two times a second clock frequency of the second clock signal.

6. The method of claim 1, wherein each clock signal in the set of clock signals is generated by a respective clock generator circuit in a set of clock generator circuits.

7. The method of claim 6, wherein the ready signal is provided to enable pins of the set of clock generator circuits.

8. A non-transitory computer-readable medium comprising stored instructions, which when executed by a processor, cause the processor to:
receive a first circuit which generates a ready signal, wherein the first circuit provides the ready signal to a second circuit, wherein the ready signal is used to stop and resume a set of clock signals in an emulation system, wherein the set of clock signals is derived from a first clock signal in the emulation system, wherein the first circuit includes at least one circuit element which is clocked by a second clock signal in the set of clock signals, and wherein the second clock signal is slower than the first clock signal; and
replace the first circuit by third circuit which is clocked by the first clock signal, and wherein the third circuit predicts a value of the ready signal at a future clock edge of the second clock signal.

9. The non-transitory computer-readable medium of claim 8, wherein the second clock signal is generated by aligning each clock edge of a third clock signal to a corresponding positive clock edge of the first clock signal.

10. The non-transitory computer-readable medium of claim 9, wherein the corresponding positive clock edge of the first clock signal is a positive clock edge of the first clock signal which is nearest to, and which occurs before the clock edge of the third clock signal.

11. The non-transitory computer-readable medium of claim 9, wherein the corresponding positive clock edge of the first clock signal is a positive clock edge of the first clock signal which is nearest to, and which occurs after the clock edge of the third clock signal.

12. The non-transitory computer-readable medium of claim 8, wherein a first clock frequency of the first clock signal is greater than or equal to two times a second clock frequency of the second clock signal.

13. The non-transitory computer-readable medium of claim 8, wherein each clock signal in the set of clock signals is generated by a respective clock generator circuit in a set of clock generator circuits.

14. The non-transitory computer-readable medium of claim 13, wherein the ready signal is provided to enable pins of the set of clock generator circuits.

15. An apparatus, comprising:
a memory storing instructions; and
a processor, coupled with the memory and to execute the instructions, the instructions when executed causing the processor to:
receive a first circuit which generates a ready signal, wherein the first circuit provides the ready signal to a second circuit, wherein the ready signal is used to stop and resume a set of clock signals in an emulation system, wherein the set of clock signals is derived from a first clock signal in the emulation system, wherein the first circuit includes at least one circuit element which is clocked by a second clock signal in the set of clock signals, and wherein a first clock frequency of the first clock signal is greater than or equal to two times a second clock frequency of the second clock signal; and
replace the first circuit by a third circuit which is clocked by the first clock signal, and wherein the third circuit predicts a value of the ready signal at a future clock edge of the second clock signal.

16. The apparatus of claim 15, wherein the second clock signal is generated by aligning each clock edge of a third clock signal to a corresponding positive clock edge of the first clock signal.

17. The apparatus of claim 16, wherein the corresponding positive clock edge of the first clock signal is a positive clock edge of the first clock signal which is nearest to, and which occurs before the clock edge of the third clock signal.

18. The apparatus of claim 16, wherein the corresponding positive clock edge of the first clock signal is a positive clock edge of the first clock signal which is nearest to, and which occurs after the clock edge of the third clock signal.

19. The apparatus of claim 15, wherein each clock signal in the set of clock signals is generated by a respective clock generator circuit in a set of clock generator circuits.

20. The apparatus of claim 19, wherein the ready signal is provided to enable pins of the set of clock generator circuits.
